(19) United States
(12) Patent Application Publication
(10) Pub. No.: US 2012/0266917 A1
(43) Pub. Date: Oct. 25, 2012

(54) COMPOSITIONS AND METHODS FOR COLLECTING OR CONTAINING A HYDROPHILIC POLYMER

(75) Inventors: Marta M. Broge, New Berlin, WI (US); Lynn Marie Johnson, Brookfield, WI (US)

(73) Assignee: Innovative Next Generation Products, Inc., New Berlin, WI (US)

(21) Appl. No.: 13/271,930

(22) Filed: Oct. 12, 2011

Related U.S. Application Data
(60) Provisional application No. 61/404,939, filed on Oct. 12, 2010.

(51) Int. Cl. C11D 7/60; B08B 1/00

(52) U.S. Cl. 134/6; 510/215; 510/365

(57) ABSTRACT

Compounds and related methods are present to assist in the collection and/or disposal of polymers and/or coagulants, such as hydrophilic long chain polymers. A compound may be provided as a mixture of a polysaccharide, a salt, and a substrate. Such mixture may be cast over an area including, e.g., a spilled hydrophilic long chain polymer, and the polymer and mixture may be easily swept up and disposed of.

### RELATED APPLICATIONS

This application claims the benefit of co-pending U.S. Provisional Patent Application Ser. NO. 61/404,939, filed 12 Oct. 2010, and entitled “Compositions and Methods for Collecting or Containing a Hydrophilic Polymer.”

### BACKGROUND OF THE INVENTION

Embodiments according to the present invention relate generally to absorbent and/or adsorbent compounds and related methods of use. More particularly, embodiments according to the present invention may be used to collect liquid polymers for disposal.

In the wastewater treatment process, for example, liquid polymers may be used for flocculation, coagulation and/or precipitation of solid particulates. Such liquid polymers are generally hydrophilic; therefore, the polymers are extremely difficult to clean (i.e., collect and dispose of) appropriately. For instance, if these liquid polymers are spilled on a floor or deposited on clothing or skin, it can be quite difficult to clean as the addition of water simply causes the polymer material to expand or swell and become sticky or tacky, itself, while at the same time decreasing the frictional effect of the surface on which the material is deposited. Indeed, even after an affected area has been scrubbed and is apparently clean, the addition of water to that area may reveal that the polymer had not been entirely cleaned up after all, thereby creating a safety concern.

Prior methods of cleaning up spilled or deposited liquid polymers included the use of salt, attempts with various aqueous solutions, acid and bleach. While some methods have proven minimally effective, such compounds are usually caustic. Accordingly, there remains room in the art for safe, improved compounds for collecting polymers and/or flocculants, especially hydrophilic powder, emulsified, or liquid polymers.

### SUMMARY OF THE INVENTION

Embodiments according to the present invention provide safe, improved compounds and related methods for collecting polymers, especially hydrophilic powder, emulsified and/or liquid polymers.

The present invention relates to a solid material, preferably in powder form, that may be deposited or scattered onto or into a spill of one or more liquid polymers, thereby resulting in charge neutralization of the polymer. The collected polymer may then be swept up, e.g. with a broom, or washed off, e.g. with water. The ingredients are preferably environmentally friendly; therefore, caustic cleaners are not required. A preferred composition includes substantially equal parts (about one part each) of corn starch, alum, sodium chloride, and flour or talc. To that composition is added preferably about two parts silica sand. In another preferred embodiment, the composition includes substantially equal parts (about one part each) of potato starch, alum, sodium chloride, and flour or talc. To that composition is added preferably about two parts pulverized volcanic pumice. In another preferred embodiment, the composition includes substantially equal parts (about one part each) of potato starch and sodium chloride. To that composition is added preferably about three parts pulverized volcanic pumice. It is believed that the mixture, when applied to a liquid polymer, helps to break long chain polymers and/or absorb or adsorb the components thereof.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

Compounds according to the present invention may generally include a first polysaccharide, an alum, a salt, a second polysaccharide or first silicate material, and a relatively durable substrate. Generally, preferred compounds comprise about two parts by volume of a substrate material mixed with about one part by volume of each other ingredient. The term “about” should be construed to mean approximately the number of stated parts, plus or minus up to about fifteen percent by weight of the ingredient. The first polysaccharide may be a starch, such as corn starch (amylose and/or amylopectin) or potato starch. A preferred starch is included in potato granules, such as Emgranule 3347, available from Emsland-Starke GmbH of Emlichheim, Germany. All of the potato granules preferably have a particle size of less than 250 micrometers, with a majority of the granules having a particle size of between about 60 micrometers and about 180 micrometers. The potato granules are preferably free from one or more major allergens and products thereof, such as: cereals containing gluten, crustaceans, eggs, fish, peanuts, soybeans, milk, tree nuts, celery, mustard, sesame seeds, lupine and mollusks.

The alum may be hydrated potassium aluminum sulfate, or conventional powdered alum. The salt may be sodium chloride. While regular granulated table salt may work, a preferred salt has a majority particle size of less than 45 micrometers, and preferably between about 65% to about 75% of the salt particles are preferably less than 45 micrometers. A preferred salt is Microsized® 66 Fine Salt, available from Cargill Salt of Minneapolis, Minn. The second polysaccharide, if used, may be a standard stoneground or otherwised processed grain flour, such as wheat flour. The first silicate material, if used, may be powdered talc, or hydrated magnesium silicate. The relatively durable substrate material may be a second silicate material, such as silica sand having a desired particle size, or a volcanic byproduct, such as preferably crushed or pulverized volcanic pumice, pumicite, or pozzolan. A preferred substrate may be a porous volcanic pumice having a maximum particle size of preferably less than two millimeters, and more preferably having a particle size of about dust to about 2.0 millimeters, and more preferably of about dust to about 1.7 millimeters. To make compounds according to the present invention, the ingredients are generally disposed in a vessel and mixed to form a substantially sample-wise homogeneous mixture, where the sample size may range from milligrams or grams to kilograms. In other words, a given sample will preferably comprise the relative ingredient amounts described, whether the sample is a teaspoon, for example, or a liter or a gallon. While various recipe mixtures are encompassed within the present invention, two preferred recipes are listed below:

### Recipe 1

About 1 part by volume potato starch

About 1 part by volume powdered alum

About 1 part by volume sodium chloride

About 1 part by volume powdered talc

About 2 parts by volume volcanic pumice

### Recipe 2

About 1 part by volume corn starch

About 1 part by volume powdered alum

About 1 part by volume sodium chloride

About 1 part by volume powdered talc

About 2 parts by volume silica sand

A compound according to the present invention may be simplified to include about one part by volume polysaccharide, about one part by volume salt, and about 3 parts by volume substrate, although other adjuncts could be added. A preferred recipe according to this embodiment is as follows:

### Recipe 3

About 1 part by volume potato starch

About 1 part by volume sodium chloride

About 3 parts by volume volcanic pumice

Compounds prepared according to the present invention are preferably non-flammable, and comprised of inert ingredients that may be readily disposed of without use of hazardous waste practices.

Compounds according to the present invention may be used in combination with or to clean up polymers and/or coagulants of various compositions. Such compositions may include various nonionic, anionic, and/or cationic acrylamides with mole charges of 0-100% molecular weight and from low to very high and active solids from 1-100%. Such compositions may be provided in various forms, such as dry, emulsion, or liquid.

To use compounds according to the present invention, an effective amount of such compound may be sprinkled, deposited or scattered over a polymer or flocculant deposit that is desired to be collected and/or disposed of. After allowing some effective time for polymer breakdown and/or adsorption and/or absorption, the mixture of compound and deposit may be swept into a dust pan, e.g. with a broom, or rinsed down a drain, if on the floor for example, or brushed or rinsed off of clothing, human skin or human hair.

Compounds according to the present invention may be provided in a relatively bulk form (which may be measured in pounds or kilograms), such as in a plastic, handled jug, adapted to be grasped by a single human hand, for use on a deposit up to a maximum size. Alternatively, compounds according to the present invention may be provided in smaller quantities (which may be measured in fractions of ounces, ounces, milligrams or grams), such as in single use packets, envelopes, or even blister packs, for use on a deposit up to a smaller maximum size.

An alternative use of compounds according to the present invention may be in the field of cosmetics or skin care. For instance, compounds according to the present invention may be further combined with and/or suspended in a preferred gel material, such as a glycerin based gel, for example. Additionally or alternatively, compounds according to the present invention may be packaged in a container that is coupled to and/or sold with a container holding a hydrophilic polymer. Additionally or alternatively, compounds according to the present invention may be packaged and/or sold apart from a hydrophilic polymer, but instructions may be provided for use as a cosmetic agent, such as an exfoliant, in conjunction with or separate and apart from a hydrophilic polymer. To use compounds according to the present invention in a cosmetic sense, for example, a hydrophilic polymer may be applied to a human skin area. Water may or may not be added to the polymer. An effective amount of a compound according to the present invention may be sprinkled onto, or otherwise interacted with, the hydrophilic polymer. Preferably, pressure may be applied so as to increase the amount of friction provided between the particles of the inventive compound and the skin surface. After a desired period of treatment of the skin surface, the compound/polymer combination may be brushed or rinsed off of the skin surface.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. A mixture comprising:
a first polysaccharide;
a salt; and
a substrate material.

2. A mixture according to claim 1, wherein the first polysaccharide is potato starch.

3. A mixture according to claim 2, wherein the salt is sodium chloride.

4. A mixture according to claim 3, wherein the substrate material is selected from the group consisting of silica sand and volcanic pumice.

5. A mixture according to claim 4 comprising:
about 1 part by volume potato starch;
about 1 part by volume sodium chloride; and
about 1 part by volume volcanic pumice.

6. A mixture according to claim 2, wherein the substrate material is selected from the group consisting of silica sand and volcanic pumice.

7. A mixture according to claim 1, wherein the salt is sodium chloride.

8. A mixture according to claim 7, wherein the substrate material is selected from the group consisting of silica sand and volcanic pumice.

9. A mixture according to claim 1, wherein the substrate material is selected from the group consisting of silica sand and volcanic pumice.

10. A mixture according to claim 1, further comprising an alum.

11. A mixture according to claim 10, wherein the alum is hydrated potassium aluminum sulfate.

12. A method comprising the steps of:
providing a mixture according to claim 1;
scattering the mixture over an area comprising a hydrophilic polymer; and
collecting the mixture and the polymer.

13. A method according to claim 12, wherein the scattering step comprises scattering the mixture over a majority of surface area of the hydrophilic polymer.

14. A method according to claim 13, wherein the scattering step comprises scattering the mixture over the entire surface area of the hydrophilic polymer.

15. A method according to claim 12, wherein the collecting step includes the step of sweeping the mixture and polymer with a broom.

16. A method according to claim 12, further comprising the step of disposing of the mixture and polymer.

17. A method according to claim 12, wherein the hydrophilic polymer is disposed on a floor.

18. A method according to claim 17, wherein the floor is a concrete floor.
